(19) United States
(12) Patent Application Publication
(10) Pub. No.: US 2021/0388671 A1
(43) Pub. Date: Dec. 16, 2021

(54) PRIVACY MESH AND ASSOCIATED METHODS

(71) Applicant: Inkable Arts, Inc., Orange, CA (US)

(72) Inventors: Cynthia Fascenelli Kirkeby, Orange, CA (US); David Anqi Chen, Fountain Valley, CA (US)

(73) Assignee: Inkable Arts, Inc., Orange, CA (US)

(21) Appl. No.: 17/283,149

(22) PCT Filed: Oct. 7, 2019
(86) PCT No.: PCT/US2019/054977

§ 371 Date: Apr. 6, 2021

Related U.S. Application Data
(60) Provisional application No. 62/744,650, filed on Oct. 12, 2018.

(51) Int. Cl. E06B 9/24; A47G 5/00

(52) U.S. Cl. CPC E06B 9/24; E06B 9/52; E06B 2009/2447; A47G 5/00

(57) ABSTRACT

A privacy mesh configured for effectively creating a one-way privacy screen in an opening of a space, along with associated methods of use and manufacture, are disclosed. In at least one embodiment, the privacy mesh provides an interior surface and an opposing exterior surface. The interior surface provides an interior visual design configured to minimize any visual obstruction created by the privacy mesh when looking through the interior surface of the privacy mesh from within the space. The exterior surface provides an exterior visual design configured to visually obscure an interior of the space when looking through the exterior surface of the privacy mesh from outside of the space. In use, the privacy mesh is positionable in, between, or in front of the opening such that the exterior surface of the privacy mesh is spaced apart from the opening, with the interior surface facing the space and the opposing exterior surface facing outwardly away from the space toward an exterior of the space.

### RELATED APPLICATIONS

This application claims priority and is entitled to the filing date of U.S. provisional application Ser. No. 62/744,650, filed on Oct. 12, 2018. The contents of the aforementioned application are incorporated herein by reference.

### BACKGROUND

The subject of this patent application relates generally to privacy screens, and more particularly to a privacy mesh and associated methods of use and manufacture, with the privacy mesh being configured for effectively creating a one-way privacy screen.

Applicant(s) hereby incorporate herein by reference any and all patents and published patent applications cited or referred to in this application.

By way of background, window coverings are often used in order to provide a degree of privacy for occupants of buildings and other spaces, including vehicles. Traditional window coverings include items such as shades, curtains, blinds, and shutters. However, while such window coverings are able to block the view into buildings and other spaces, the trade-off is that they typically also block the view out of those buildings/spaces. As a result, occupants of such buildings/spaces are left with the choice of: a) closing curtains, blinds, or shutters in order to keep people from looking into their building/space while at the same time losing their view of the outside world; or b) leaving open their window coverings so they can maintain their view while also allowing strangers to look into their building/space as they walk by. Décor options in the window covering category is largely limited to the choice of materials and color. In certain cases, a manufacturer may offer printed imagery solutions, but the prints are usually done on opaque materials.

In commercial window covering contexts, there is a serious need for a privacy solution that can protect sensitive business materials from visual hacking. Today's offices are increasingly reducing the square footage per office. As an example, coworking/shared office spaces for a single person can average a mere 36 square feet. To accommodate this space reduction without triggering claustrophobic reactions to the small spaces, coworking spaces and offices typically provide glass-walled office spaces to make the spaces feel larger than they actually are. Although the transparent walls make these small spaces more comfortable to work in, they leave the occupants and all of their sensitive business assets exposed. To solve the problem, the occupants often use partial frosted window appliques, which keep people from looking in but also blocks the occupant from seeing out. Thus, current solutions are not sufficient.

Another type of breach of privacy that is possible in these transparent workspaces is covert sound surveillance by visual microphones as seen in recent MIT research. By taking high speed video of items in a room, even through a pane of sound-proof glass, minute movements of the item (such as the leaves of a plant) can be used to recreate sound the object was exposed to. A visual barrier is therefore needed to obscure the interior and limit this form of covert intrusion.

Screens are another type of common door and window item, and are traditionally utilized for keeping bugs, animals, and other errant materials from entering a structure while maintaining varying amounts of airflow. These screens are primarily made of dark grey or black mesh material that absorb sunlight.

Solar screens have also become more prevalent in recent years as people try to keep their homes cooler in the summer. Such screens are typically made of a specialized tight-weave polyester mesh, or polyester mesh with PVC coating. Solar screens are typically black or dark-colored material, and frequently are installed on the exterior of a building, essentially blocking out the window and thereby theoretically reducing heat gain coefficients. The heat transfer reduction is not especially effective, especially if the material is internally mounted. The other drawbacks of these screens is that the weave is so tight that they substantially, if not almost completely, inhibit airflow and the severe reduction to internal light levels can be detrimental to the mental health of the occupants, with studies showing an increase in depression related to low light levels.

Stickers and window wraps are also becoming more prevalent in recent years—more so for advertising purposes rather than privacy. However, it has been found that such stickers and window wraps are less than ideal when it comes to providing privacy. Specifically, given that these types of products are adhered directly to a window, it has been found that they tend to lose their ability to obscure an interior space when the viewer (exterior to the space/window) uses a cell phone or spy camera positioned relatively close to the sticker/window wrap (within a few inches of the sticker/window wrap). Thus, the privacy benefits can be easily undermined by a simple camera that is able to focus past such window applications.

Accordingly, with respect to window coverings, along with screen doors and windows, Applicant has identified at least seven areas of concern or interest—each of which needs to be taken into consideration when developing a solution to the above-described problems in the art: 1) pest control, 2) air permeability, 3) solar mitigation (summer) or 4) solar gain (winter), 5) light levels, 6) glare control, and 7) customizable décor.

Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing a privacy mesh and associated methods of use and manufacture, with the privacy mesh being configured for effectively creating a one-way privacy screen. In at least one embodiment, the privacy mesh provides an interior surface and an opposing exterior surface. The interior surface provides an interior visual design configured to minimize any visual obstruction created by the privacy mesh when looking through the interior surface of the privacy mesh from within the space. The exterior surface provides an exterior visual design configured to visually obscure an interior of the space when looking through the exterior surface of the privacy mesh from outside of the space. In use, the privacy mesh is positionable in, between, or in front of, the opening, such that the exterior surface of the privacy mesh is spaced apart from the opening, with the interior surface facing the space and the opposing exterior surface facing outwardly away from the space toward an exterior of the space.

In at least one embodiment, the privacy mesh is manufactured by first selecting a sheet of mesh material, the mesh material having an interior surface and an opposing exterior surface. A backing sheet is temporarily affixed to at least one of the interior and exterior surfaces of the mesh material. An exterior visual design is applied to the exterior surface of the mesh material, and the backing sheet is subsequently removed from the interior surface of the mesh material.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is an illustration of an exemplary privacy mesh, with a corner of the mesh folded over on itself, showing both an interior surface and an opposing exterior surface thereof, in accordance with at least one embodiment;

FIG. 2 is an image of an exemplary interior space as looking through an unobstructed, uncovered window;

FIG. 3 is an image of the same interior space of FIG. 2, but illustrating the effect of inter-object imagery occlusion with exemplary privacy mesh embodiments, in accordance with at least one embodiment, positioned over a portion of said image;

FIG. 4 is an image of an exemplary privacy mesh configured as a screen door, showing the exterior surface thereof, in accordance with at least one embodiment;

FIG. 5 is a further image of the privacy mesh of FIG. 4, showing the interior surface thereof, in accordance with at least one embodiment;

FIG. 6 is a flow diagram of an exemplary method for manufacturing an exemplary non-metal privacy mesh, in accordance with at least one embodiment; and

FIG. 7 is a flow diagram of an exemplary method for manufacturing an exemplary metal privacy mesh, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

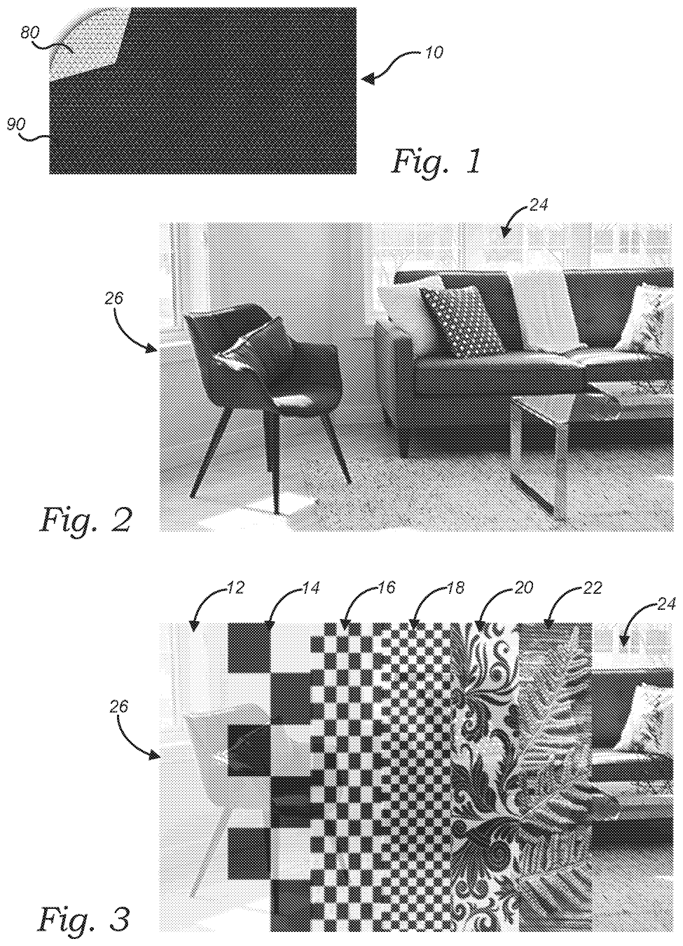

Turning now to FIG. 1, there is shown an illustration of an exemplary privacy mesh 10 configured for effectively creating a one-way privacy screen, as discussed further below. In at least one embodiment, the privacy mesh 10 comprises an interior surface 90 and an opposing exterior surface 80, such that the privacy mesh 10 is configured for being positioned in, between, or in front of, a window or doorway or between two adjoining spaces (hereinafter generally referred to as an “opening” 26 for simplicity purposes) of a building, room, vehicle or other space where an opening might be positioned (hereinafter generally referred to as a “space” 24 for simplicity purposes). In at least one such embodiment, the privacy mesh 10 may be configured as a screen door, window screen, or window covering, with the privacy mesh 10 being positioned in a spaced-apart relationship with the corresponding opening 26.

The privacy mesh 10 is configured for being oriented such that the interior surface 90 of the privacy mesh 10 faces the space 24, while the exterior surface 80 of the privacy mesh 10 faces outwardly away from the space 24, toward an exterior of the space 24. In at least one embodiment, the privacy mesh 10 is substantially planar; however, in at least one alternate embodiment, the privacy mesh 10 is substantially curved. At the outset, it should be noted that the size, shape, dimensions, texture and weave density of the privacy mesh 10 depicted in the drawings is merely exemplary and shown for illustrative purposes. As such, in further embodiments, the privacy mesh 10 may take on any other size, shape, dimensions, texture and/or weave density, now known or later developed—dependent at least in part on the size, shape, and dimensions of the space 24 within which the privacy mesh 10 is to be positioned. Similarly, the specific colors and patterns of the privacy mesh 10 depicted in the drawings are also merely exemplary and shown for illustrative purposes. As such, in further embodiments, the privacy mesh 10 may incorporate any other colors and/or patterns—now known or later developed—capable of allowing the privacy mesh 10 to function as described herein.

In at least one embodiment, the privacy mesh 10 is constructed out of a non-metal material, such as polyester, fiberglass, cotton, hemp, nylon, or glass fiber, for example. In further such embodiments, the privacy mesh 10 may be constructed out of any other non-metal material (or combination of non-metal materials)—now known or later developed—capable of allowing the privacy mesh 10 to function as described herein. In at least one alternate embodiment, the privacy mesh 10 is constructed out of a metal material, such as aluminum, copper, stainless steel, brass, bronze or other metals or alloys, for example. In further such embodiments, the privacy mesh 10 may be constructed out of any other metal material (or combination of metal materials)—now known or later developed—capable of allowing the privacy mesh 10 to function as described herein. In at least one further alternate embodiment, the privacy mesh 10 is constructed out of a combination of non-metal and metal materials. Additionally, in at least one embodiment, the material 10 provides a protective coating, such as a PVC coating for example.

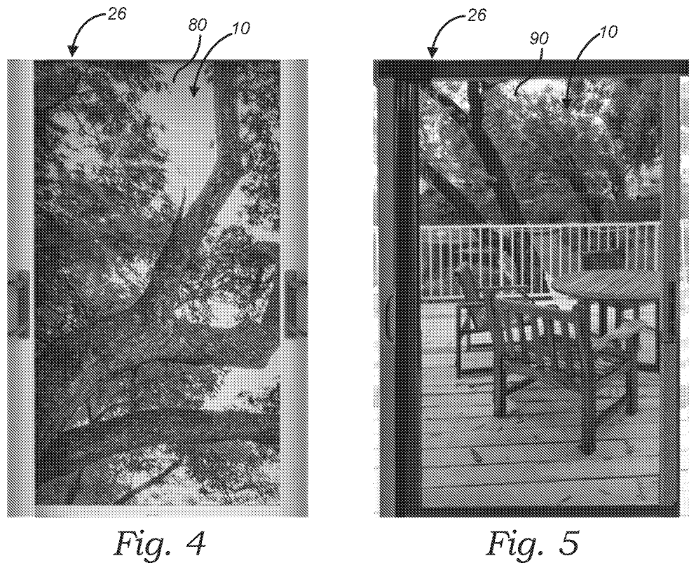

In at least one embodiment, the interior surface 90 of the privacy mesh 10 is substantially uniform and relatively dark in color (such as deep shade colors comprised of, but not limited to dark blue, navy, dark green, deep red, burgundy, dark brown, deep purple, deep russet, black and charcoal, for example), so as to minimize any visual obstruction created by the privacy mesh 10 when looking through the privacy mesh 10 from within the space 24 (i.e., when looking through the opening 26 from inside the space 24), as illustrated in FIG. 5. In further embodiments, the interior surface 90 may have any other color or shade of color, now known or later developed—dependent at least in part on the desired use of the privacy mesh 10 and the associated space 24 within which the privacy mesh 10 is positioned, as discussed further below. Additionally, in at least one embodiment, the exterior surface 80 of the privacy mesh 10 is relatively lighter in color than the interior surface 90, so as to maximize the visual obstruction created by the privacy mesh 10 when looking through the privacy mesh 10 from outside of the space 24 (i.e., when looking through the opening 26 from the exterior of the space 24), as illustrated in FIG. 4. In at least one further embodiment, the exterior surface 80 of the privacy mesh 10 provides an exterior visual design comprising one or more images and/or patterns thereon—again, so as to maximize the visual obstruction created by the privacy mesh 10 when looking through the privacy mesh 10 from outside of the space 24. In at least one such embodiment, the images and/or patterns provided by the exterior surface 80 are positioned and configured for creating an inter-object occlusion, whereby the images and/or patterns provided by the exterior surface 80 visually obscure the interior of the space 24, in whole or in part). In at least one further such embodiment, the images and/or patterns provided by the exterior surface 80 are positioned and configured for creating an imagery interference, whereby the color wavelengths of the images and/or patterns provided by the exterior surface 80 visually cancel out the color wavelengths of the interior of the space 24. In still further such embodiments, the images and/or patterns provided by the exterior surface 80 may employ other optical techniques—now known or later developed—capable of visually obscuring the interior of the space 24, while maintaining an unobstructed view when looking through the privacy mesh 10 from within the space 24 (by virtue of the interior surface 90 of the privacy mesh 10). Thus, in further embodiments, the exterior surface 80 may have any other color, shade of color, imagery and/or pattern now known or later developed—dependent at least in part on the desired use of the privacy mesh 10 and the associated space 24 within which the privacy mesh 10 is positioned, as discussed further below. Additionally, the relatively dark, uniform color of the opposing interior surface 90 of the privacy mesh 10 makes the color/imagery/pattern on the exterior surface 80 essentially disappear from the viewpoint of individuals positioned within the space 24, while the privacy mesh 10 itself becomes largely transparent from the viewpoint of such individuals positioned within the space 24. In at least one further embodiment, the interior surface 90 may employ a non-uniform color, imagery and/or pattern, such that a person viewing the privacy mesh 10 from within the space 24 (i.e., looking at the interior surface 90) is able to see a different image than a person viewing the privacy mesh 10 from outside the space 24 (i.e., looking at the exterior surface 80).

To further illustrate the functionality of the privacy mesh 10, FIG. 2 is an image of an exemplary interior space 24 as looking through an unobstructed, uncovered opening 26, while FIG. 3 is an image of the same interior space 24 of FIG. 2, but illustrating the effect of inter-object imagery occlusion created by various colors/imagery/patterns positioned on the exterior surface 80 of the privacy mesh 10, thereby creating a visual obstruction when looking through the privacy mesh 10 from outside of the space 24. For illustrative purposes only, portions of a plurality of exemplary privacy mesh 10 embodiments (each having a transparency value of 70% based on a weave density of the privacy mesh 10) are positioned in a side-by-side arrangement in FIG. 3, arranged from a relatively simple, single-colored tonal occlusion to increasingly more complex design occlusions. In a bit more detail, a first portion 12 illustrates the exterior surface 80 having a solid white color; a second portion 14 illustrates the exterior surface 80 having a large checkerboard pattern; a third portion 16 illustrates the exterior surface 80 having a medium checkerboard pattern; a fourth portion 18 illustrates the exterior surface 80 having a small checkerboard pattern; a fifth portion 20 illustrates the exterior surface 80 having an ornamental pattern; and a sixth portion 22 illustrates the exterior surface 80 having a photographic image of leaves. A further illustration of an exemplary exterior surface 80 is shown in FIG. 4. Thus, in at least one embodiment, the more complicated or intricate the colors/imagery/patterns positioned on the exterior surface 80, the more extensive the privacy effect of the privacy mesh 10 becomes. The effectiveness of the privacy mesh 10 tends to be greatest during daytime conditions; however, the privacy mesh 10 may also be sufficiently effective during nighttime conditions as well, depending on lighting conditions inside and outside of the space 24.

Furthermore, unlike prior art stickers and window wraps, the privacy mesh 10 is not affixed directly to the corresponding opening 26, and therefore does not fall victim to the same vulnerability of such prior art products. As noted above, the privacy mesh 10 is configured for being positioned in a spaced-apart relationship with the corresponding opening 26. Camera devices having an autofocus lens (i.e., devices which might be used by those trying to quickly and inconspicuously spy on the interior of the space 24) are typically programmed to detect indicators of sharpness, contrast and/or light. Thus, when such camera devices are positioned in close proximity to (i.e., within inches of) prior art stickers and window wraps, the camera devices are typically able to focus through such prior art products and into the interior of the space 24. With the privacy mesh 10 on the other hand, since there is always a gap between the privacy mesh 10 and the corresponding opening 26 (when used as a window covering or a screen), such camera devices are unable to focus past the exterior surface 80 of the privacy mesh 10 and see into the interior of the space 24. In at least one embodiment, the privacy mesh 10 also prohibits the use of visual acoustic spying, since a clear view of the interior of the space 24 is obstructed by the exterior surface 80 of the privacy mesh 10 and cannot be filmed with the level of detail required for visual acoustic spying.

In at least one embodiment, in addition to the privacy-enhancement and view preservation qualities discussed above, the privacy mesh 10 also embodies additional favorable traits comprised of, but not limited to, pest control, air permeability, solar mitigation (in warmer climates) and solar gain (in colder climates), interior light control, glare control, and customizable décor. In at least one such embodiment, given that the privacy mesh 10 is capable of mitigating heat and allowing for airflow (with operational windows and doors), the privacy mesh 10 can reduce energy consumption of the associated space 24 when used as a window covering or screen. At the same time, when the space is a commercial or retail establishment, the associated businesses retain the ability to brand and add design elements to the privacy mesh 10, while maintaining maximum visibility to the exterior world for customers shopping within the space 24. Additionally, in embodiments where the exterior surface 80 of the privacy mesh 10 has a light-to-white tonality, the privacy mesh 10 has a relatively higher solar reflectance index (“SRI”)—which is a measure of a constructed surface's ability to stay cool in the sun by reflecting solar radiation and emitting thermal radiation—thereby enabling the privacy mesh 10 to provide significant solar mitigation in warmer climates (such as during summer months). Similarly, in embodiments where the exterior surface 80 of the privacy mesh 10 has a relatively darker tonality, the privacy mesh 10 has a relatively lower solar reflectance index (“SRI”), thereby enabling the privacy mesh 10 to absorb heat, which can be useful in colder climates (such as during winter months). Additionally, in embodiments where the privacy mesh 10 is configured as a screen, the privacy mesh 10 allows for airflow into and out of the space 24. In at least one embodiment, depending on the weave density of the privacy mesh 10, the air permeability of the privacy mesh 10 may range between 1,000 liter/m²/second and 7,500 liter/m²/second. Thus, by incorporating the privacy mesh 10 into a window or door screen, the occupant is able to maintain adequate ventilation of the space 24 without any loss in privacy. Furthermore, for homeowners, the privacy provided by the privacy mesh 10 can encourage the use of open windows for ventilated cooling rather than energy intensive air conditioning, where proximity to neighbors or foot traffic may have had an effect on such use (since “opening up a home” traditionally would also mean a loss of privacy). The ventilated privacy barrier created by the privacy mesh 10 is especially desirable in areas with scenic views, thereby allowing the occupant of the space 24 to enjoy the exterior view and breeze without the obstruction of a curtain, a solid shade, shutters or other solid barrier that would obstruct their view and airflow, and still being afforded a significant level of privacy from and persons outside of the space 24.

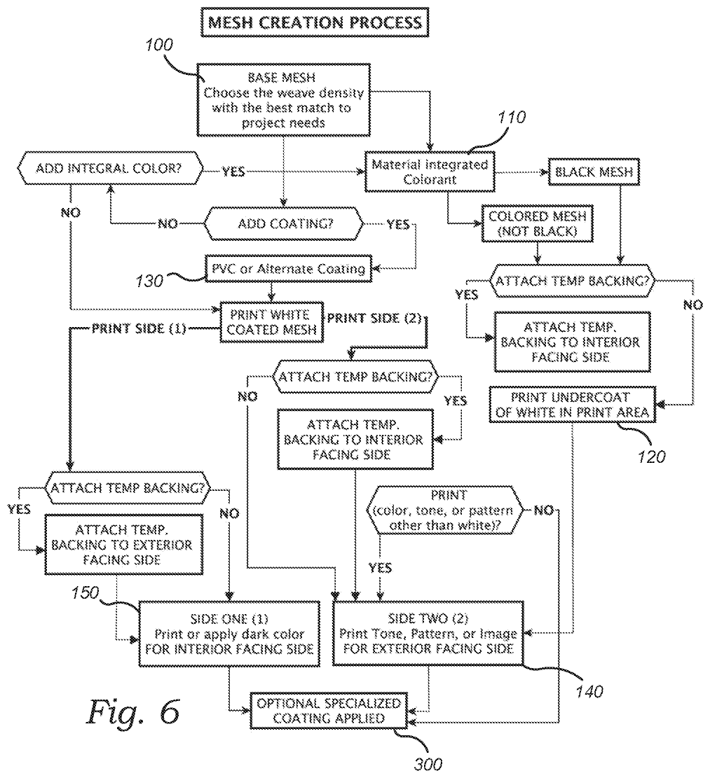

Exemplary methods of manufacturing the privacy mesh 10 are illustrated in the flow diagrams of FIG. 6 (where the privacy mesh 10 is constructed out of a non-metal material) and 7 (where the privacy mesh 10 is constructed out of a metal material). In at least one embodiment, where the privacy mesh 10 is constructed out of a non-metal material (FIG. 6), the process begins with selecting a sheet of the underlying mesh material itself, making sure that material has a weave density that will best suit the desired use of the privacy mesh 10 and the associated space 24 within which the privacy mesh 10 will be positioned (100). Additionally, if a protective coating is desired—such as a PVC coating, for example—it is applied to the mesh material (130). In at least one embodiment, where the interior surface 90 of the privacy mesh 10 is to be relatively dark in color, a mesh material having such a dark color is selected (110), thereby eliminating the need to apply further color to the interior surface 90. In at least one such embodiment, the mesh material is toned by colorants such as, but not limited to, inks, dyes, eco-solvent inks, latex inks, or colorants that are incorporated into the mesh material during its manufacturing process such that it becomes integral to the subsequently produced privacy mesh 10. Otherwise, where the dark color is not integral to the mesh material, the necessary dark color is subsequently applied to the interior surface 90 using dyes, inks, paints or other coating materials (150). In at least one such embodiment, prior to adding the dark color to the interior surface 90, a backing sheet is temporarily adhered to the exterior surface 80 so as to prevent any colorants (i.e., inks, dyes, paints, coatings, etc.) intended for the interior surface 90 to overspray, bleed or otherwise run onto the opposing exterior surface 80. This helps to keep the exterior visual design on the exterior surface 80 from being unintentionally darkened by the interior surface 90 colorants. In at least one embodiment, if the mesh material is coated (130), the desired coloring may be integrated into the coating before it is applied to the mesh material. In at least one embodiment, prior to adding the desired colors/imagery/patterns of the exterior visual design to the exterior surface 80, a backing sheet is temporarily adhered to the interior surface 90 so as to prevent any colorants (i.e., inks, dyes, paints, coatings, etc.) intended for the exterior surface 80 to overspray, bleed or otherwise run onto the interior surface 90. In at least one alternate embodiment, no backing sheet is adhered to the interior surface 90 prior to adding the exterior visual design to the exterior surface 80. Where the mesh material has an integral dark color, a light colored (such as white, for example) undercoat is applied to the exterior surface 80 (120) so as to provide a relatively light colored surface on which the desired colors/imagery/patterns may be applied to the exterior surface 80 (140). In at least one embodiment, a final step may involve applying one or more specialized coatings to one or both of the exterior surface 80 and interior surface 90 so as to prolong the lightfastness of colors or facilitate other beneficial effects (300).

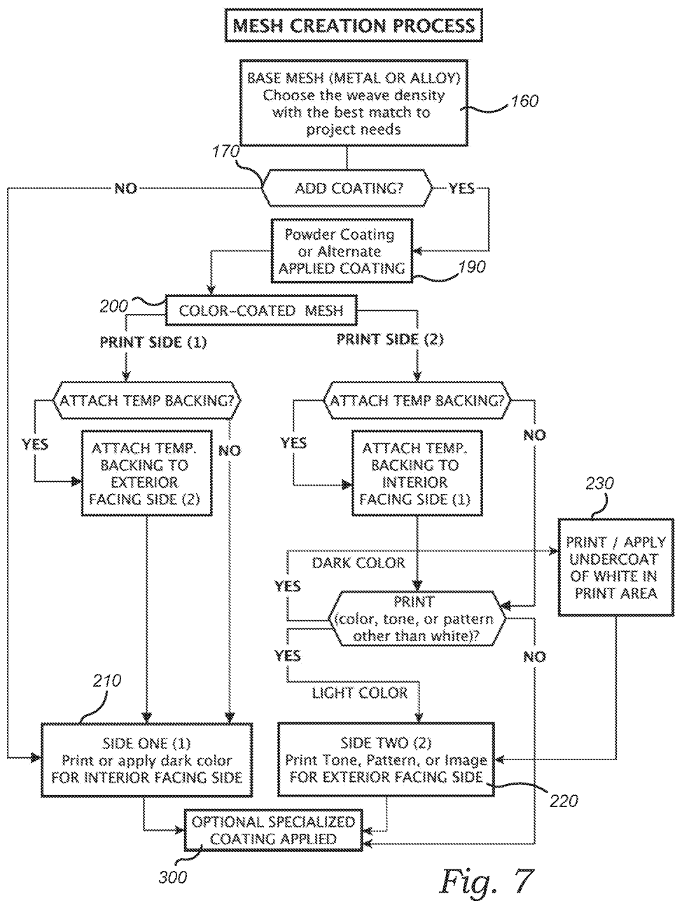

In at least one embodiment, where the privacy mesh 10 is constructed out of a metal material (FIG. 7), the process begins with selecting a sheet of the underlying mesh material itself, making sure that material has a weave density that will best suit the desired use of the privacy mesh 10 and the associated space 24 within which the privacy mesh 10 will be positioned (160). Additionally, if a protective coating is desired (170)—such as a PVC or powder coating, for example—it is applied to the mesh material (190). In at least one embodiment, where the interior surface 90 of the privacy mesh 10 is to be relatively dark in color, the mesh material may be color coated with such a dark color (200), thereby eliminating the need to apply further color to the interior surface 90. In at least one such embodiment, the mesh material is toned by colorants such as, but not limited to, inks, dyes, eco-solvent inks, latex inks, paints or other types of color coatings. In at least one alternate embodiment, the coloration is achieved through a chemical applied patina of the metal. Additionally, in at least one embodiment, if the mesh material is coated (190), the desired coloring may be integrated into the coating before it is applied to the mesh material. Otherwise, where the mesh material is not coated with the dark color, the necessary dark color is subsequently applied to the interior surface 90 using dyes, inks, paints or other coating materials (210). In at least one such embodiment, prior to adding the dark color to the interior surface 90, a backing sheet is temporarily adhered to the exterior surface 80 so as to prevent any colorants (i.e., inks, dyes, paints, coatings, etc.) intended for the interior surface 90 to overspray, bleed or otherwise run onto the opposing exterior surface 80. This helps to keep the exterior visual design on the exterior surface 80 from being unintentionally darkened by the interior surface 90 colorants. In at least one embodiment, prior to adding the desired colors/imagery/patterns of the exterior visual design to the exterior surface 80, a backing sheet is temporarily adhered to the interior surface 90 so as to prevent any colorants (i.e., inks, dyes, paints, coatings, etc.) intended for the exterior surface 80 to overspray, bleed or otherwise run onto the interior surface 90. In at least one alternate embodiment, no backing sheet is adhered to the interior surface 90 prior to adding the exterior visual design to the exterior surface 80. Where the mesh material is coated with the dark color, a light colored (such as white, for example) undercoat is applied to the exterior surface 80 (230) so as to provide a relatively light colored surface on which the desired colors/imagery/patterns may be applied to the exterior surface 80 (220). In at least one embodiment, a final step may involve applying one or more specialized coatings to one or both of the exterior surface 80 and interior surface 90 so as to prolong the lightfastness of colors or facilitate other beneficial effects (300).

Aspects of the present specification may also be described as the following embodiments:

1. A privacy mesh configured for creating a one-way privacy screen in an opening of a space, the privacy mesh comprising: an interior surface and an opposing exterior surface; the interior surface providing an interior visual design configured to minimize any visual obstruction created by the privacy mesh when looking through the interior surface of the privacy mesh from within the space; and the exterior surface providing an exterior visual design configured to visually obscure an interior of the space when looking through the exterior surface of the privacy mesh from outside of the space; whereby, the privacy mesh is positionable in, between, or in front of the opening such that the exterior surface of the privacy mesh is spaced apart from the opening, with the interior surface facing the space and the opposing exterior surface facing outwardly away from the space toward an exterior of the space.

2. The privacy mesh according to embodiment 1, wherein the interior visual design is a substantially uniform color.

3. The privacy mesh according to embodiments 1-2, wherein the color of the interior visual design is dark.

4. The privacy mesh according to embodiments 1-3, wherein the color of the interior visual design is one of dark blue, navy, dark green, deep red, burgundy, dark brown, deep purple, deep russet, black and charcoal.

5. The privacy mesh according to embodiments 1-4, wherein the interior visual design comprises at least one of a solid color, a pattern, and an image.

6. The privacy mesh according to embodiments 1-5, wherein the exterior visual design is relatively lighter in color than the interior visual design.

7. The privacy mesh according to embodiments 1-6, wherein the exterior visual design comprises at least one of a solid color, a pattern, and an image.

8. The privacy mesh according to embodiments 1-7, wherein the exterior visual design is configured for creating an inter-object occlusion, whereby the exterior visual design visually obscures the interior of the space, in whole or in part.

9. The privacy mesh according to embodiments 1-8, wherein the exterior visual design is configured for creating an imagery interference, whereby an at least one color wavelength of the exterior visual design visually cancels out an at least one corresponding color wavelength of the interior of the space.

10. The privacy mesh according to embodiments 1-9, wherein the privacy mesh is configured as a window screen.

11. The privacy mesh according to embodiments 1-10, wherein the privacy mesh is configured as a window covering.

12. The privacy mesh according to embodiments 1-11, wherein the privacy mesh is configured as a screen door.

13. The privacy mesh according to embodiments 1-12, wherein the privacy mesh is substantially planar.

14. The privacy mesh according to embodiments 1-13, wherein the privacy mesh is substantially curved.

15. The privacy mesh according to embodiments 1-14, wherein the privacy mesh is constructed out of a non-metal material.

16. The privacy mesh according to embodiments 1-15, wherein the non-metal material incorporates at least one of polyester, fiberglass, cotton, hemp, nylon, and glass fiber.

17. The privacy mesh according to embodiments 1-16, wherein the privacy mesh is constructed out of a metal material.

18. The privacy mesh according to embodiments 1-17, wherein the metal material incorporates at least one of aluminum, copper, stainless steel, brass, bronze, and alloy.

19. The privacy mesh according to embodiments 1-18, wherein the privacy mesh is constructed out of a combination of non-metal and metal materials.

20. The privacy mesh according to embodiments 1-19, wherein the privacy mesh provides a protective coating.

21. The privacy mesh according to embodiments 1-20, wherein the protective coating is a PVC coating.

22. A privacy mesh configured for creating a one-way privacy screen in an opening of a space, the privacy mesh comprising: an interior surface and an opposing exterior surface; the interior surface providing an interior visual design having a dark, substantially uniform color so as to minimize any visual obstruction created by the privacy mesh when looking through the interior surface of the privacy mesh from within the space; and the exterior surface providing an exterior visual design relatively lighter in color than the interior visual design, the exterior visual design comprising at least one of a solid color, a pattern, and an image configured to visually obscure an interior of the space when looking through the exterior surface of the privacy mesh from outside of the space; whereby, the privacy mesh is positionable in, between, or in front of the opening such that the exterior surface of the privacy mesh is spaced apart from the opening, with the interior surface facing the space and the opposing exterior surface facing outwardly away from the space toward an exterior of the space.

23. A method of manufacturing the privacy mesh of claim 1, the method comprising the steps of: selecting a sheet of mesh material, the mesh material having an interior surface and an opposing exterior surface; temporarily affixing a backing sheet to the exterior surface of the mesh material; applying a dark color to the interior surface of the mesh material; removing the backing sheet from the exterior surface of the mesh material; and applying an exterior visual design to the exterior surface of the mesh material.

24. The method according to embodiment 23, wherein the step of selecting a sheet of mesh material further comprises the step of selecting a sheet of mesh material having a desired weave density.

25. The method according to embodiments 23-24, wherein the step of selecting a sheet of mesh material further comprises the step of selecting a sheet of mesh material constructed out of at least one of a non-metal material and a metal material.

26. The method according to embodiments 23-25, wherein the step of selecting a sheet of mesh material further comprises the step of selecting a sheet of mesh material having a dark color.

27. The method according to embodiments 23-26, wherein the step of selecting a sheet of mesh material having a dark color further comprises the step of selecting a sheet of dark blue, navy, dark green, deep red, burgundy, dark brown, deep purple, deep russet, black or charcoal colored mesh material.

28. The method according to embodiments 23-27, further comprising the step of applying a protective coating to the mesh material.

29. The method according to embodiments 23-28, wherein the step of applying a protective coating further comprises the step of applying a PVC coating to the mesh material.

30. The method according to embodiments 23-29, further comprising the step of integrating a dark color into the protective coating.

31. The method according to embodiments 23-30, wherein the step of applying a dark color to the interior surface of the mesh material further comprises the step of applying one of dark blue, navy, dark green, deep red, burgundy, dark brown, deep purple, deep russet, black and charcoal to the interior surface.

32. The method according to embodiments 23-31, wherein the step of temporarily affixing a backing sheet to the exterior surface of the mesh material further comprises the step of affixing the backing sheet to the exterior surface using a temporary adhesive.

33. The method according to embodiments 23-32, further comprising the step of applying a light colored undercoat to the exterior surface of the mesh material, where the mesh material has an integral dark color.

34. The method according to embodiments 23-33, further comprising the steps of: temporarily affixing a backing sheet to the interior surface of the mesh material prior to applying the exterior visual design to the exterior surface of the mesh material; and removing the backing sheet from the interior surface of the mesh material after applying the exterior visual design to the exterior surface of the mesh material.

35. The method according to embodiments 23-34, wherein the step of temporarily affixing a backing sheet to the interior surface of the mesh material further comprises the step of affixing the backing sheet to the interior surface using a temporary adhesive.

36. The method according to embodiments 23-35, wherein the step of applying a light colored undercoat to the exterior surface of the mesh material further comprises applying a white colored undercoat to the exterior surface.

37. The method according to embodiments 23-36, wherein the step of applying an exterior visual design to the exterior surface of the mesh material further comprises the step of applying at least one of a solid color, a pattern, and an image to the exterior surface.

38. The method according to embodiments 23-37, further comprising the step of applying one or more specialized coatings to one or both of the exterior surface and interior surface of the mesh material so as to prolong the lightfastness of colors thereon.

In closing, regarding the exemplary embodiments of the present invention as shown and described herein, it will be appreciated that a privacy mesh configured for effectively creating a one-way privacy screen, along with associated methods of use and manufacture, are disclosed. Because the principles of the invention may be practiced in a number of configurations beyond those shown and described, it is to be understood that the invention is not in any way limited by the exemplary embodiments, but is generally directed to a privacy mesh and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the logic code, programs, modules, processes, methods, and the order in which the respective elements of each method are performed are purely exemplary. Depending on the implementation, they may be performed in any order or in parallel, unless indicated otherwise in the present disclosure.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A privacy mesh configured for creating a one-way privacy screen in an opening of a space, the privacy mesh comprising:
an interior surface and an opposing exterior surface;
the interior surface providing an interior visual design configured to minimize any visual obstruction created by the privacy mesh when looking through the interior surface of the privacy mesh from within the space; and
the exterior surface providing an exterior visual design configured to visually obscure an interior of the space when looking through the exterior surface of the privacy mesh from outside of the space;
whereby, the privacy mesh is positionable in, between, or in front of the opening such that the exterior surface of the privacy mesh is spaced apart from the opening, with the interior surface facing the space and the opposing exterior surface facing outwardly away from the space toward an exterior of the space.

2. The privacy mesh of claim 1, wherein the interior visual design is a substantially uniform color.

3. The privacy mesh of claim 2, wherein the color of the interior visual design is dark.

4. The privacy mesh of claim 1, wherein the exterior visual design is relatively lighter in color than the interior visual design.

5. The privacy mesh of claim 1, wherein the exterior visual design comprises at least one of a solid color, a pattern, and an image.

6. The privacy mesh of claim 5, wherein the exterior visual design is configured for creating an inter-object occlusion, whereby the exterior visual design visually obscures the interior of the space, in whole or in part.

7. The privacy mesh of claim 5, wherein the exterior visual design is configured for creating an imagery interference, whereby an at least one color wavelength of the exterior visual design visually cancels out an at least one corresponding color wavelength of the interior of the space.

8. The privacy mesh of claim 1, wherein the privacy mesh is constructed out of a non-metal material.

9. The privacy mesh of claim 8, wherein the non-metal material incorporates at least one of polyester, fiberglass, cotton, hemp, nylon, and glass fiber.

10. The privacy mesh of claim 1, wherein the privacy mesh is constructed out of a metal material.

11. The privacy mesh of claim 10, wherein the metal material incorporates at least one of aluminum, copper, stainless steel, brass, bronze, and alloy.

12. The privacy mesh of claim 1, wherein the privacy mesh provides a protective coating.

13. A privacy mesh configured for creating a one-way privacy screen in an opening of a space, the privacy mesh comprising:
an interior surface and an opposing exterior surface;
the interior surface providing an interior visual design having a dark, substantially uniform color so as to minimize any visual obstruction created by the privacy mesh when looking through the interior surface of the privacy mesh from within the space; and
the exterior surface providing an exterior visual design relatively lighter in color than the interior visual design, the exterior visual design comprising at least one of a solid color, a pattern, and an image configured to visually obscure an interior of the space when looking through the exterior surface of the privacy mesh from outside of the space;
whereby, the privacy mesh is positionable in, between, or in front of the opening such that the exterior surface of the privacy mesh is spaced apart from the opening, with the interior surface facing the space and the opposing exterior surface facing outwardly away from the space toward an exterior of the space.

14. A method of manufacturing the privacy mesh of claim 1, the method comprising the steps of:
selecting a sheet of mesh material, the mesh material having an interior surface and an opposing exterior surface;
temporarily affixing a backing sheet to the exterior surface of the mesh material;
applying a dark color to the interior surface of the mesh material;
removing the backing sheet from the exterior surface of the mesh material; and
applying an exterior visual design to the exterior surface of the mesh material.

15. The method of claim 14, wherein the step of selecting a sheet of mesh material further comprises the step of selecting a sheet of mesh material having a dark color.

16. The method of claim 14, further comprising the step of applying a protective coating to the mesh material.

17. The method of claim 14, wherein the step of applying a dark color to the interior surface of the mesh material further comprises the step of applying one of dark blue, navy, dark green, deep red, burgundy, dark brown, deep purple, deep russet, black and charcoal to the interior surface.

18. The method of claim 14, further comprising the step of applying a light colored undercoat to the exterior surface of the mesh material, where the mesh material has an integral dark color.

19. The method of claim 14, wherein the step of applying an exterior visual design to the exterior surface of the mesh material further comprises the step of applying at least one of a solid color, a pattern, and an image to the exterior surface.

20. The method of claim 14, further comprising the step of applying one or more specialized coatings to one or both of the exterior surface and interior surface of the mesh material so as to prolong the lightfastness of colors thereon.
